(19) United States
(12) Patent Application Publication
(10) Pub. No.: US 2026/0202219 A1
(43) Pub. Date: Jul. 16, 2026

(54) ON-AXIS MAGNETIC ROTARY ENCODER EMPLOYING A FIELD-ENHANCING MAGNETIC ASSEMBLY

(71) Applicant: Novanta Inc., Bedford, MA (US)

(72) Inventors: Paul A. Remillard, Littleton, MA (US); Deepak Surendran, Wilmington, MA (US); Brian Scott Dawson, Dublin, VA (US)

(21) Appl. No.: 19/445,840

(22) Filed: Jan. 12, 2026

Related U.S. Application Data
(60) Provisional application No. 63/744,978, filed on Jan. 14, 2025.

(51) Int. Cl. G01D 5/14; G01D 5/249; H01F 7/02

(52) U.S. Cl. CPC G01D 5/142; G01D 5/2497; H01F 7/02

(57) ABSTRACT

A magnetic assembly for a rotary encoder, includes at least two axially-magnetized permanent magnets, wherein the magnets are arranged such that their magnetic polarities are oriented in opposite directions to produce a concentrated magnetic field.

### CROSS REFERENCE TO RELATED APPLICATIONS

This application claims the benefit of priority under 35 U.S.C. § 119(e) and 37 C.F.R. § 1.78 to provisional application no. 63/744,978 filed on Jan. 14, 2025, titled “ON-AXIS MAGNETIC ROTARY ENCODER EMPLOYING A FIELD-ENHANCING MAGNETIC ASSEMBLY” which is hereby incorporated by reference herein in its entirety.

### BACKGROUND

Off-axis rotary magnetic encoders based on an annular array of distinct magnetized elements are in general use now, as are on-axis rotary magnetic encoders utilizing the field of a single dipole magnet. These are both common in a variety of applications such as autonomous mobile robots, collaborative robots or “cobots”, industrial automation, and surgical robots. However, such encoders suffer from relatively large size and crosstalk between neighboring rotational axes. Improved encoders are sought.

### BRIEF SUMMARY

In one embodiment, a magnetic assembly for a rotary encoder, includes: at least two axially-magnetized permanent magnets, wherein the magnets are arranged such that their polarities are oriented in opposite directions to produce a concentrated magnetic field.

Optionally in some embodiments, the magnetic axes of the at least two permanent magnets are substantially parallel to one another.

Optionally in some embodiments, the at least two permanent magnets include at least four permanent magnets; at least one of the at least four permanent magnets is arranged adjacent to at least two other of the at least four permanent magnets, the at least one permanent magnet is oriented with its polarity in a first orientation, one of the at least two adjacent permanent magnets is oriented with its polarity in the first orientation, and the other of the at least two adjacent permanent magnets is oriented with its polarity in a second configuration opposite the first configuration.

Optionally in some embodiments, the permanent magnets are arranged in a square array.

Optionally in some embodiments, the at least four magnets are rectangular and secured in pairs.

Optionally in some embodiments, the magnetic assembly, further includes a flux conducting element coupled to a first end of the at least two axially magnetized permanent magnets, wherein a flux conducting element is normal to easy axes of the at least two axially aligned permanent magnets.

Optionally in some embodiments, the first end includes a non-working end of the magnetic assembly.

Optionally in some embodiments, the magnetic assembly further includes a second end opposite the first end, and the second end includes a working end of the magnetic assembly, from which the concentrated magnetic field emanates.

Optionally in some embodiments, the at least two permanent magnets are arranged to reduce a lateral extension of the magnetic field.

Optionally in some embodiments, the at least two permanent magnets are of a same geometric shape.

Optionally in some embodiments, the magnetic assembly further includes an additional magnetic dipole disposed at an end of the at least two permanent magnets.

Optionally in some embodiments, the magnetic axes of the at least two permanent magnets are not parallel to one another.

Optionally in some embodiments, the at least two permanent magnets include at least six permanent magnets.

Optionally in some embodiments, the at least six permanent magnets are arranged in a triangular or hexagonal prism.

Optionally in some embodiments, the at least two permanent magnets includes a facet or a stepped feature disposed at at least one end.

Optionally in some embodiments, a magnetic assembly includes an interstitial element disposed between the at least two permanent magnets.

Optionally in some embodiments, the at least two permanent magnets include at least four permanent magnets, a first of the at least four permanent magnets is adjacent to a second of the at least four permanent magnets, a third of the at least four permanent magnets is adjacent to a fourth of the at least four permanent magnets, the first and second permanent magnets are arranged such that their polarities are oriented in a same first direction, the third and fourth permanent magnets are arranged such that their polarities are oriented in a same second direction opposite the first direction, and the interstitial element is disposed between the first permanent magnet and the third or fourth permanent magnet.

Optionally in some embodiments, the at least two permanent magnets include at least six permanent magnets and the interstitial element is disposed between any two of the at least six permanent magnets.

Optionally in some embodiments, the at least two permanent magnets are semi cylindrical in shape.

Optionally in some embodiments, the interstitial element includes a magnetically permeable material.

Optionally in some embodiments, the interstitial element includes a magnetically non-permeable material.

Optionally in some embodiments, the magnetic assembly includes at least one sensor disposed in the concentrated magnetic field, where the at least one sensor is configured to measure a tilt of the magnetic assembly.

Optionally in some embodiments, the concentrated magnetic field is disposed on opposite sides of the at least two permanent magnets; and the at least one sensor includes a first sensor disposed in the concentrated magnetic field on a first side of the opposite sides, and a second sensor disposed in the concentrated magnetic field on a second of the opposite sides.

Optionally in some embodiments, a magnetic assembly includes a ferrous element, where the at least two permanent magnets comprise at least four permanent magnets, a first of the at least four permanent magnets is adjacent to a second of the at least four permanent magnets, the first and second permanent magnets forming a first pair of permanent magnets having mutually oppositely-aligned polarities, a third of the at least four permanent magnets is adjacent to a fourth of the at least four permanent magnets, the third and fourth permanent magnets forming a second pair of permanent magnets having mutually oppositely-aligned polarities, the ferrous element is disposed between the first pair of permanent magnets and the second pair of permanent magnets, the first sensor is disposed in the concentrated magnetic field formed by the first pair of permanent magnets, and the second sensor is disposed in the concentrated magnetic field formed by the second pair of permanent magnets.

In various embodiments, a rotary encoder includes: the magnetic assembly of any of the preceding clauses; and a sensor selectively disposed within and configured to detect the concentrated magnetic field.

In one embodiment, a rotary encoder includes: a magnetic assembly including: at least two axially-magnetized permanent magnets, wherein the magnets are arranged such that their magnetic polarities are oriented in opposite directions to produce a concentrated magnetic field; a sensor selectively disposed within and configured to detect the concentrated magnetic field.

Optionally in some embodiments, the sensor includes a magnetoresistance sensor.

Optionally in some embodiments, the preferred magnetic axes of the at least two permanent magnets are substantially parallel to one another.

Optionally in some embodiments, the at least two permanent magnets include at least four permanent magnets; at least one of the at least four permanent magnets is arranged adjacent to at least two other of the at least four permanent magnets, the at least one permanent magnet is oriented with its magnetic polarity in a first orientation, one of the at least two adjacent permanent magnets is oriented with its magnetic polarity in the first orientation, and the other of the at least two adjacent permanent magnets is oriented with its magnetic polarity in a second configuration opposite the first configuration.

Optionally in some embodiments, the at least four magnets are arranged in a polygonal shape.

Optionally in some embodiments, the at least four magnets are rectangular and secured in pairs.

### BRIEF DESCRIPTION OF THE DRAWINGS

FIG. 1 is a simplified schematic view of an embodiment of a magnetic assembly of the present disclosure.

FIG. 2A is a simplified schematic of a single magnetic dipole.

FIG. 2B is a simplified schematic of the magnetic assembly of FIG. 1, showing an example of a concentrated magnetic field.

FIG. 3A is a simplified schematic view of an embodiment of a magnetic assembly of the present disclosure.

FIG. 3B is a schematic plan view of the magnetic assembly of FIG. 3A.

FIG. 3C is a perspective view of the magnetic assembly of FIG. 3A.

FIG. 3D is a simplified schematic view of an embodiment of a magnetic assembly of the present disclosure.

FIG. 3E is a schematic plan view of the magnetic assembly of FIG. 3A.

FIG. 4A is a simplified plan view of an embodiment of a magnetic assembly of the present disclosure.

FIG. 4B is a cross section view of the magnetic assembly of FIG. 4A taken along line 4B-4B of FIG. 4A.

FIG. 4C is a cross section view of a magnetic assembly of FIG. 4A taken along line 4B-4B of FIG. 4A including optional magnetic elements.

FIG. 5 is a simplified cross-section view of an embodiment of a magnetic assembly of the present disclosure.

FIG. 6 is a simplified cross-section view of an embodiment of a magnetic assembly of the present disclosure.

FIG. 7 is a simplified cross-section view of an embodiment of a magnetic assembly of the present disclosure.

FIG. 8A is a simplified plan view of an embodiment of a magnetic assembly of the present disclosure.

FIG. 8B is a simplified plan view of an embodiment of a magnetic assembly of the present disclosure.

FIG. 8C is a simplified plan view of an embodiment of a magnetic assembly of the present disclosure.

FIG. 8D is a simplified plan view of an embodiment of a magnetic assembly of the present disclosure.

FIG. 9A is a simplified cross-section view of an embodiment of a magnetic assembly of the present disclosure.

FIG. 9B is a simplified cross-section view of an embodiment of a magnetic assembly of the present disclosure.

FIG. 10 is a simplified schematic of an example of an encoder suitable for use with the magnetic assemblies disclosed herein.

### DETAILED DESCRIPTION

A magnetic on-axis, rotary, absolute position encoder based on special magnet configurations is described and disclosed herein. In various embodiments, the disclosed encoder is compact in size, consumes little power, is low cost, can be easily installed and aligned, and provides an accurate high resolution position output. Its unique magnet assemblies are composed of specially arranged and/or shaped magnetic elements. In various embodiments, magnetic sensing is performed by an appropriate sensor.

The magnet assemblies of the present disclosure use multiple magnets to form a concentrated dipole field with benefits for on-axis sensing where absolute rotary position encoding is desired. The disclosed encoders are well-suited for the robotic and other automation applications, such as unmanned vehicles (e.g., any of terrestrial, aerial, or marine vehicles), autonomous mobile robots, automated guided vehicles, etc. but with performance and ease-of-use advantages over existing encoders afforded by the novel magnet configurations and/or shapes. These advantages include, but are not limited to, smaller size, lower weight, and reduced crosstalk between neighboring rotational axes compared to existing encoders.

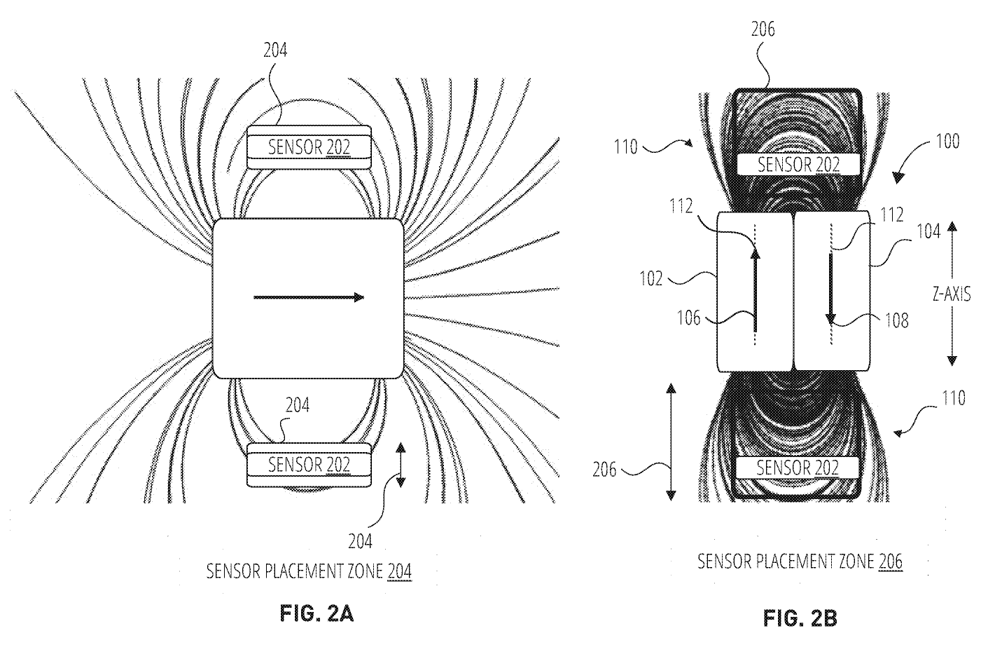

The disclosed concentrated dipole field provides the adequate flux density at the on-axis sensor for detection of the magnetic field of the dipole, but it is narrow in the radial direction. For example, the strength of the field 110 reduces at a high rate of change as a function of the distance from the easy axis 112, compared to a single dipole. See, e.g., the relatively high density of the field lines in the magnetic assembly 100 of FIG. 2B, compared to the single dipole of FIG. 2A. Lateral concentration of the primary field 110 reduces undesirable stray fields that could interfere with other nearby axes or instruments. This lateral shrinkage of the field means that the field strength falls off quickly side-to-side, minimizing fields that could interfere with other nearby axes. This feature of the disclosed magnetic arrays enables smaller overall system design compared to existing encoders. For example, the field 110 drops off with a steeper radial gradient (e.g., in the directions transverse, normal, or lateral to the z-direction) than in a single dipole magnet piece (e.g., the single dipole of FIG. 2A). This steep radial gradient enables use of the magnetic assembly 100 in motor assemblies that are closely packed together.

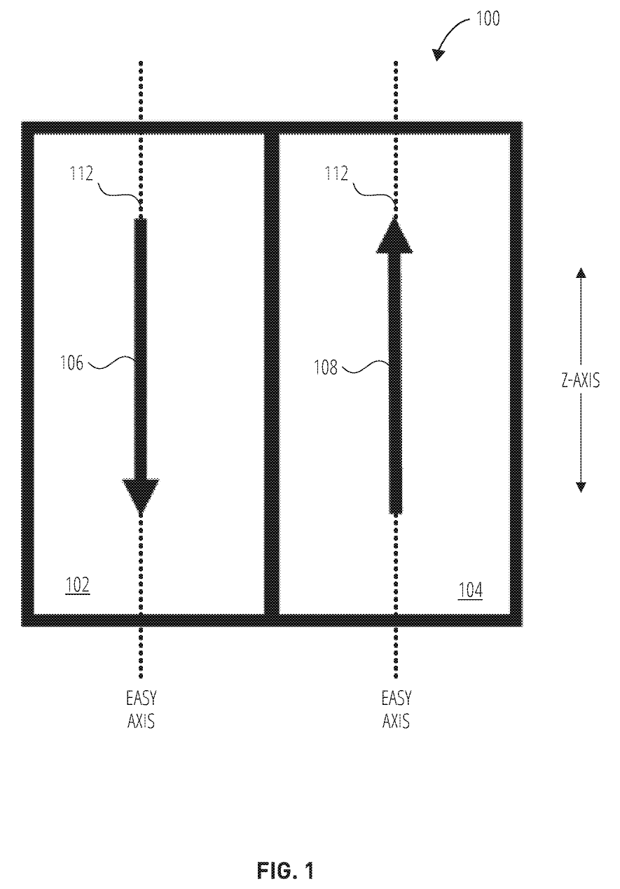

In many embodiments, the disclosed magnet assemblies include multiple (e.g., two or more), axially-magnetized permanent magnets, secured together with their magnetic moments parallel but arranged in opposite polarities or directions. See, e.g., FIG. 1 showing a simplified schematic of a magnetic assembly 100 including two magnetic elements, e.g., a first magnetic element 102 and a second magnetic element 104. The first magnetic element 102 and the second magnetic element 104 are arranged with their respective first magnetic moment 106 and second magnetic moment 108 substantially in parallel(e.g., with the easy axes 112 aligned to one another within about 15°), but oriented in opposite directions, indicated by the arrows in FIG. 1 (e.g., extending outwards in separate North/South configurations). This composite structure produces a smooth-shaped dipole field with few irregularities or harmonics, but with an overall shape favorably “distorted” into its compressed dimensions at the sensor location (e.g., a relatively narrow lateral field normal to the magnetic moments, and extending axially in parallel with the magnetic moments). The field produced by the disclosed magnetic assembly 100 provides more design flexibility than the field of a standard single dipole magnet presently used in many existing magnetic encoders (e.g., is better suited to compact, light-weight encoder configurations).

Various magnet assembly configurations described in this disclosure are options for the encoder designer, each generating the optimized dipole field, but each with its unique characteristics to suit the needs of the particular encoder system being designed. Field strength, axial flux density gradient, field lateral reach, and the presence or absence of stray fields can all be tuned as needed by the shape, size, orientation, and number of magnets in the assembly, along with the presence or absence of ferrous material and or other dipole elements to direct and contain the fields. For example, two or more magnets in a magnet assembly may have complementary shapes that affect one or more properties of the magnetic field. Individual elements in a magnet assembly may have the same shape as one another or may be formed with different shapes.

With the sensor positioned in the field such that the lines of flux run parallel to the surface of the sensor, and with that field being essentially uniform at the sensor, the direction of the field relative to the rotational orientation of the sensor is detected, i.e., the signals out of the sensor device provide a quantified indication of the field direction. As the magnetic assembly 100 is rotated, the sensor signal output changes, providing a measure of the rotary position of the magnetic assembly 100. The output varies sinusoidally as a function of the angular orientation of the magnetic assembly 100, and with the sensor typically providing two differential signals in quadrature, sine and cosine signals are generated – signals that can be interpolated for a high-resolution rotary encoder position output.

In various embodiments, the sensor may be a magnetoresistance sensor, such as a tunnel magnetoresistance (TMR), giant magnetoresistance (GMR) sensor, anisotropic magnetoresistance sensor (AMR), or other sensor suitable to detect the magnetic field of the magnetic assembly.

The split magnetic assemblies and encoders disclosed herein offer several advantages over traditional encoders such as encoders that use a single magnetic dipole. The disclosed magnetic assemblies and encoders result in less interference with nearby magnetic encoders, reducing crosstalk and enabling greater multi-axis density. The disclosed magnetic assemblies also provide expanded field tolerance along the z-axis and allow for easier and more precise tailoring of the magnetic field around the sensor compared to traditional encoders. Additionally, the disclosed magnetic assemblies achieve a smaller size and lighter weight compared to traditional encoders, while maintaining flux density at a given z-distance. The disclosed magnetic assemblies and encoders facilitate flexible manufacturing and commercial availability due at least in part to their increase performance compared to existing solutions.

FIG. 2A is a schematic showing magnetic flux for a typical existing dipole magnet. FIG. 2B shows an example of the magnetic flux for an embodiment of the disclosed magnetic assemblies (e.g., the magnetic assembly 100). Both FIGS. 2A and FIG. 2B are normalized for the magnetic flux density at a specified distance above the surface of the magnet suitable to be detected by a sensor 202. To achieve comparable field strengths, the single dipole of FIG. 2A would need to be substantially larger in size and weight than the magnetic assembly 100 of FIG. 2B and other magnetic assemblies disclosed herein. Thus, the disclosed magnetic assemblies provide benefits over existing solutions in terms of packing density, lower weight, and reduced volume.

The improved magnetic assemblies disclosed include multiple, discrete axially-magnetized permanent magnet elements (e.g., a first magnetic element 102 and at least a second magnetic element 104) whose easy axis 112 orientations are aligned e.g., as shown for example in FIGS. 1 and FIG. 2B. In the field of magnetics, the easy or EZ axis refers to the direction within a magnetic material along which magnetization can occur with the least amount of energy. Such magnetic assemblies may be referred to herein as “split magnet” configurations or the like. This alignment of easy axis 112 concentrates fields in the Z-axis (e.g., normal to the easy axis 112 shown for example in FIGS. 1 and FIG. 2B) and narrows the field 110 radially compared to a single magnetic element shown in FIG. 2A.

By laterally compressing the field 110 of the disclosed magnetic assemblies, the field strength is concentrated into a narrow “column” of magnetic flux, resulting in higher flux density for greater signal strength at the specified location than would be achieved with a single dipole of similar volume of magnetic material (e.g., as shown in FIG. 2A) in a more standard, magnetic encoder configuration. While the dipole field of the single magnet shown for example in FIG. 2A is scattered, the field of the multi-piece magnet arrangement of the present disclosure (e.g., as shown for example in FIG. 2B) is focused and contained to a region above and below the magnetic assembly 100. As FIG. 2B demonstrates, multiple magnetic assemblies 100 with split magnet configurations can be placed close to each other to encode position for different motor axes without causing crosstalk compared to a typical dipole magnet. For example, compare FIG. 2A, a magnetic assembly with an unfocussed, dispersed magnetic field with a magnetic assembly 100 of the present disclosure shown for example in FIG. 2B exhibiting a shaped and focused magnetic field.

The improved flux density in the Z direction allows the sensor 202 to be placed either closer to the magnetic assembly or farther from the magnetic assembly, whichever is desired, improving misalignment tolerance in Z. See, e.g., the narrow band of sensor placement zone 204 of a single magnet shown in FIG. 2A compared to the expanded sensor placement zone 206 of the magnetic assembly 100, shown for example in FIG. 2B. The shaping of the magnetic field of the magnetic assembly 100 means that the sensor 202 can be positioned over a deeper axial range than in a typical magnetic encoder, i.e., the encoder of this disclosure has a deeper alignment tolerance than that of single dipole-based encoders. In some embodiments, the magnetic assembly 100 may include a second sensor 202 disposed in a second sensor placement zone 206 on an opposite side of the first magnetic element 102 and second magnetic element 104 from the first sensor 202. The use of a second sensor 202 may enable the magnetic assembly 100 to measure tilt and/or misalignment of the magnetic assembly 100.

The compression of the field 110 in the z-direction has the added benefit of pulling the flux lines away from the surrounding area, side-to-side. Since the field narrows radially (e.g., transverse to the Z-direction), this narrowing also allows neighboring motor axes (particularly parallel motor axes) to be placed closer to each other, due to lower crosstalk. This combination of improved z-alignment and enhanced motor axis density, while providing a sufficiently uniform field at the magnetic sensor for good fidelity signals, is a major benefit of the disclosed encoders. In some applications such as surgical robots, multiple axes are packed close together, clustered in compact groups, and often those axes are aligned parallel to one another, putting neighbors into a condition that is most sensitive to undesirable pick-up and crosstalk from nearby magnetic fields. The compression of the field in the z-direction of the disclosed encoders minimizes this unwanted crosstalk, making the disclosed encoders well suited for surgical robots and similar applications.

The concentrated field of the disclosed encoders also boosts signal strength making the disclosed encoders especially suited for use as position feedback integrated into miniature motors with extremely small power consumption requirements. The improved flux density in the Z direction allows the sensor 202 to be placed either closer to the magnetic assembly or farther from the magnetic assembly, whichever is desired, improving misalignment tolerance in Z.

Since the multi-piece permanent magnet configuration focuses the field to a desired area, the sensor 202 can be closer to the magnetic assembly 100, reducing the overall dimensions of the system. Additionally, due to the increased magnetic efficiency afforded by the concentrated field of the magnetic assembly 100, a smaller magnet material volume is needed (compared to a single magnet) to achieve the desired signal level suitable to be detected by the sensor 202, thereby reducing encoder weight. Furthermore, the disclosed flexibility of constructing the variety of magnetic assemblies ensures low cost and enables customization of the encoder system with little supply chain risk. For example, the disclosed magnetic assemblies can be tailored to a variety of applications, while reducing cost, weight, and crosstalk compared to existing encoders.

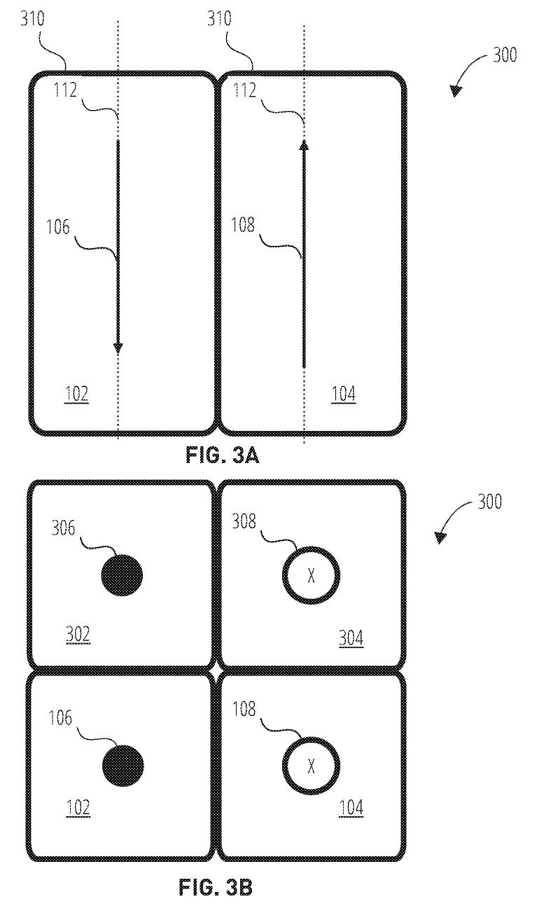

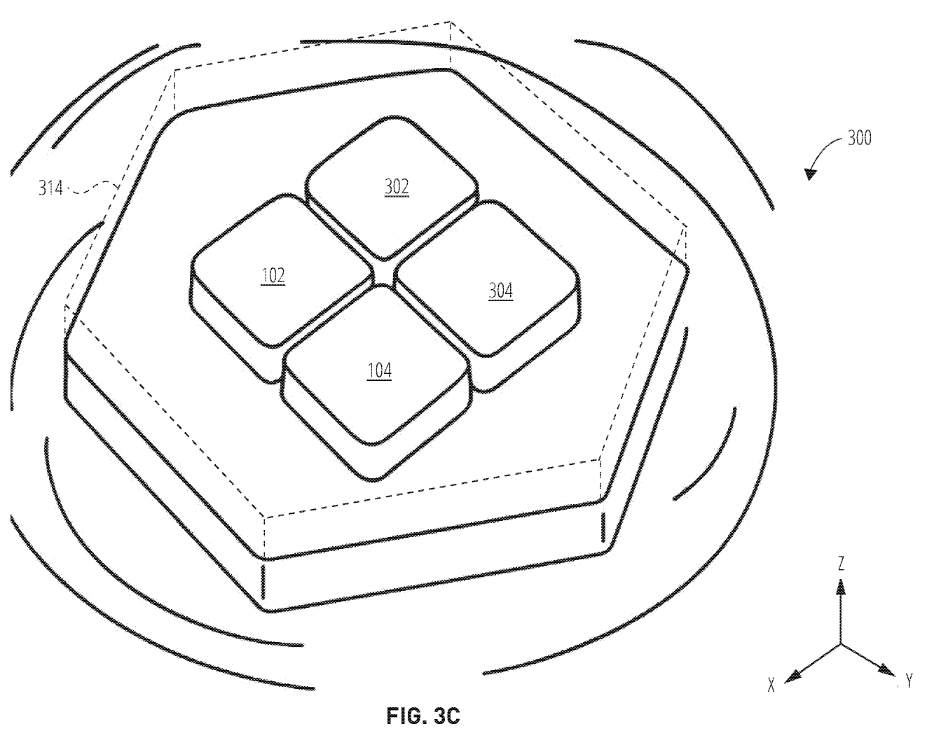

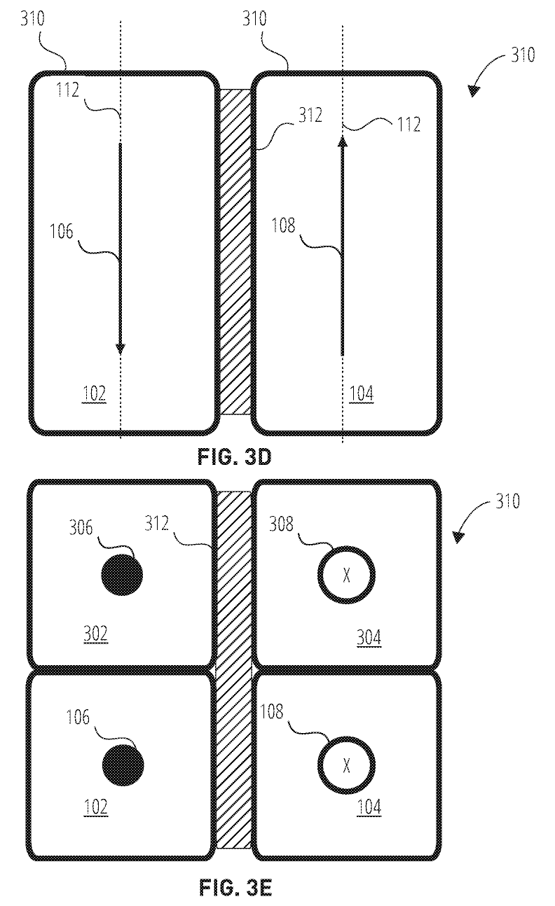

With reference to FIGS. 3A through FIG. 3C, an embodiment of a split magnetic assembly 300 including two or more axially magnetized permanent magnets arranged to produce a diametric dipole field at the sensor 202 location. For example, the magnetic assembly 300 includes a first magnetic element 102, a second magnetic element 104, a third magnetic element 302, and a fourth magnetic element 304. The four piece split magnetic assembly 300 augments the magnetic field so that it falls off quickly in the x and y direction while providing the required field levels at a particular z height. This allows other magnet encoder axes to be packed closer together than a dipole magnet. In some embodiments, the magnetic elements may be rounded, chamfered, or have other edge features. In some embodiments, the magnetic elements may have a draft, taper, or corner relief that can aid in manufacturing of the magnetic elements.

As shown for example in FIGS. 3A through FIG. 3C, to form a 4-piece split magnetic assembly 300, two axially magnetized permanent magnets with oppositely oriented poles (e.g., the first magnetic element 102 and second magnetic element 104) are individually coupled or secured (e.g., glued, adhered, affixed, or otherwise fastened) to one another. Two or more such pairs (e.g., a second pair including a third magnetic element 302 and a fourth magnetic element 304) may then be coupled or secured to each other. Each pair is formed by joining the two axially magnetized rectangular magnets with the easy axis 112 pointing in the opposite direction. For example, the third magnetic moment 306 of the third magnetic element 302 may be oriented in an opposite orientation to the fourth magnetic moment 308 of the fourth magnetic element 304. The magnets are coupled together so that they are secured in the desired configuration, as shown for example in FIG. 3B. Two of the pairs are then secured together with the poles aligned as to repel each other. In many embodiments, the magnetic assembly 300 may be arranged such that the magnetic elements form a square array, but other array shapes are envisioned.

For example, a first magnet (e.g., the first magnetic element 102) of the at least four magnets may be oriented with its magnetic moment in a first orientation . At least two others of the at least four magnets may be adjacent to the first magnet (e.g., the second magnetic element 104 and the third magnetic element 302). One of these at least two adjacent magnets (e.g., one of the second magnetic element 104 or the third magnetic element 302) may have its magnetic moment oriented in the same orientation as the first magnetic element 102. The second of the two adjacent magnets (e.g., the other of the second magnetic element 104 or the third magnetic element 302) may have its magnetic moment oriented in an opposite orientation to those of the first magnet, and the first adjacent magnet.

This configuration creates a working magnetic field at both ends of the magnetic assembly 300. This field drops off with a steeper radial gradient (e.g., in the x and y directions shown in FIG. 3C) than in a single dipole magnet piece (e.g., the single dipole of FIG. 2A). This steep radial gradient enables use of the magnetic assembly 300 in motor assemblies that are closely packed together. When the magnetic elements are put together in an assembly, a substantially uniform field is produced if the face of the assembly is a square or other symmetrical shape with minimal variation of the radial dimension to improve uniformity of the magnetic field.

The magnetic assembly 300 provides at its ends a diametric, uniform magnetic field along the axis of rotation in a X/Y plane but allows Z axis magnetic field variance but the diametric angle along z will not vary significantly.

As shown for example in FIG. 3C, the magnetic assembly 300 may include an enclosure 314 (shown in phantom lines) that at least partially, or entirely covers the first magnetic elements 102. The enclosure 314 may be made of a magnetically permeable material, such that the field 110 can extend through the enclosure 314. For example, the enclosure 314 may be a lid, cap, or molded coating that covers the magnetic elements of the magnetic assembly 300. Any of the magnetic assemblies disclosed herein may include a suitable enclosure 314.

Turning to FIGS. 3D–3E, an embodiment of a magnetic assembly 310 is shown. The magnetic assembly 310 is similar to the magnetic assembly 300. For example, the magnetic assembly 310 includes a first magnetic element 102, a second magnetic element 104, a first magnetic moment 106, a second magnetic moment 108, an easy axis 112, a third magnetic element 302, a fourth magnetic element 304, a third magnetic moment 306, a fourth magnetic moment 308, a magnetic assembly 310.

Where the magnetic assembly 310 differs from the magnetic assembly 300 is that an interstitial element 312 is disposed between two or more of the magnetic elements. For example, the interstitial element 312 may be disposed between the first magnetic element 102 and the second magnetic element 104. The interstitial element 312 may be disposed between the third magnetic element 302 and the fourth magnetic element 304. In some embodiments, the interstitial element 312 may be disposed between the first magnetic element 102 and the third magnetic element 302. In some embodiments, the interstitial element 312 may be disposed between the second magnetic element 104 and the fourth magnetic element 304. In some embodiments, the interstitial element 312 may be a magnetically permeable material. In some embodiments, the interstitial element 312 may be a magnetically non-permeable material. The interstitial element 312 may be suitable to shape the field 110 of any of the magnetic assemblies disclosed herein.

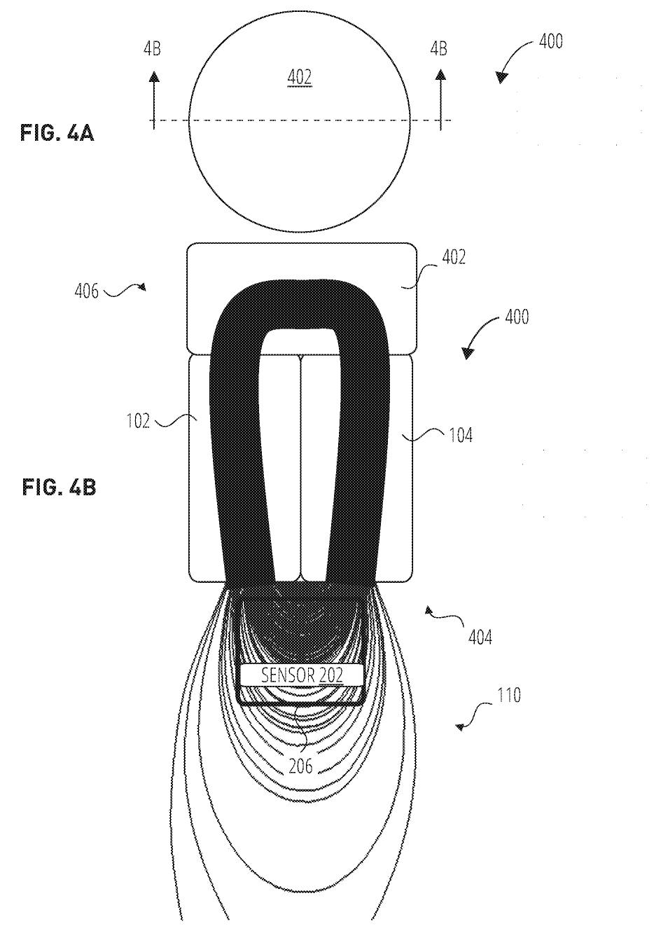

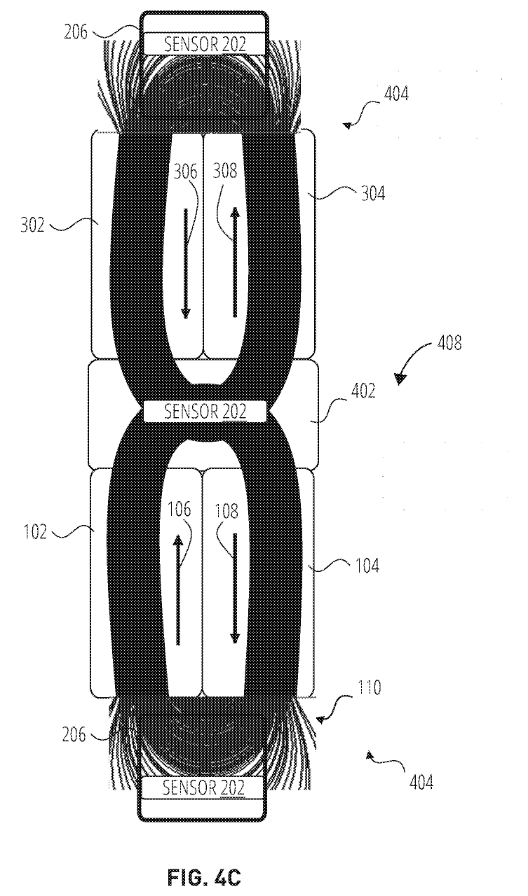

With reference to FIGS. 4A and FIG. 4B, an embodiment of a split magnetic assembly 400 for use with an encoder is disclosed. The magnetic assembly 400 includes two or more axially magnetized permanent magnets arranged to produce a diametric dipole field at the sensor location. The multi-piece magnetic assembly 400 can have two or more magnetic elements (e.g., a first magnetic element 102 and a second magnetic element 104, similar to those of the magnetic assembly 100 or four magnetic elements with a third magnetic element 302 and 304 similar to the magnetic assembly 300).

A single working end multi-piece configuration can be achieved by placing a ferrous element 402 (e.g., plate) on the opposite side of the working end 404 of the multi-piece magnetic assembly 400 as shown for example in FIG. 4A and FIG. 4B. Thus, the working end 404 of the magnetic assembly 400 has been magnetically enhanced for longer Z height operation at the working end 404 and field reduction at the non-working end 406.

Some benefits of the magnetic assembly 400 include even further reduced crosstalk, further concentration and extension of the field 110, and the resulting increased packing density of encoders compared to the magnetic assembly 100 and magnetic assembly 300.

Turning to FIG. 4C, a magnetic assembly 408 is shown. The magnetic assembly 408 is similar to the magnetic assembly 400 in many aspects. For example, the magnetic assembly 408 may include a first magnetic element 102, a second magnetic element 104, a first magnetic moment 106, a second magnetic moment 108, a field 110, a sensor 202, a sensor placement zone 206, a working end 404, a ferrous element 402, and a magnetic assembly 408.

Where the magnetic assembly 408 differs from the magnetic assembly 400 is that the magnetic assembly 408 includes a third magnetic element 302, a fourth magnetic element 304, having respective third magnetic moment 306, and a fourth magnetic moment 308. The third magnetic element 302 and the fourth magnetic element 304 may be disposed on an opposite side of the ferrous element 402 from the first magnetic element 102 and the second magnetic element 104. The magnetic assembly 408 may be adapted to measure tilt and/or misalignment of the magnetic assembly 408.

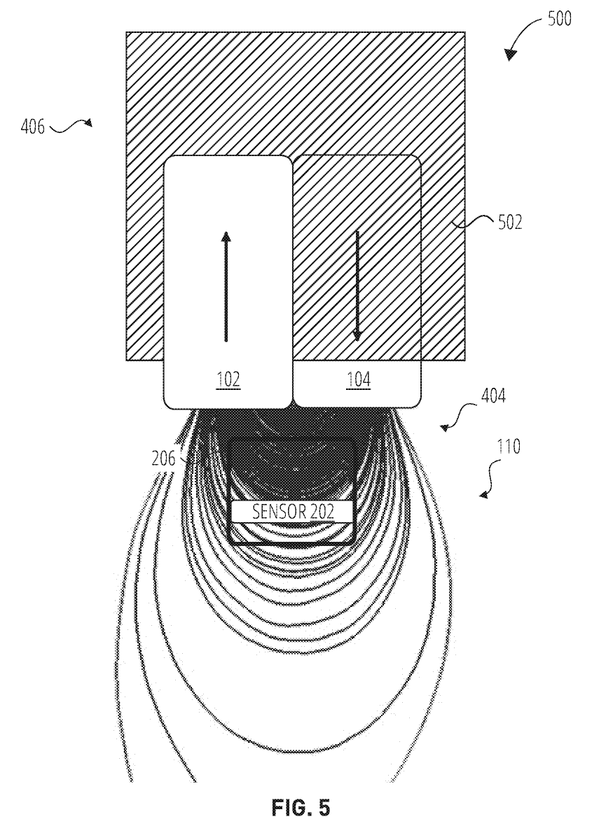

With reference to FIG. 5, an embodiment a split magnetic assembly 500 is disclosed. The magnetic assembly 500 includes two or more axially magnetized permanent magnets arranged to produce a diametric dipole field at the sensor location. The multi-piece magnetic assembly 500 can have two or more magnetic elements (e.g., a first magnetic element 102 and a second magnetic element 104, similar to those of the magnetic assembly 100 or four magnetic elements with a third magnetic element 302 and 304 similar to the magnetic assembly 300).

The magnetic assembly 500 includes an enhanced single working side multi-piece configuration along the non-working end 406 as described with respect to the magnetic assembly 400. The magnetic assembly 500 includes additional ferrous material of an extended ferrous element 502 along the non-working end 406 relative to the ferrous element 402. This additional ferrous material shunts the sides of the magnets so that fields 110 do not emanate along the non-working ends 406. This configuration provides the improved packing density of rotation axes without magnetic field crosstalk

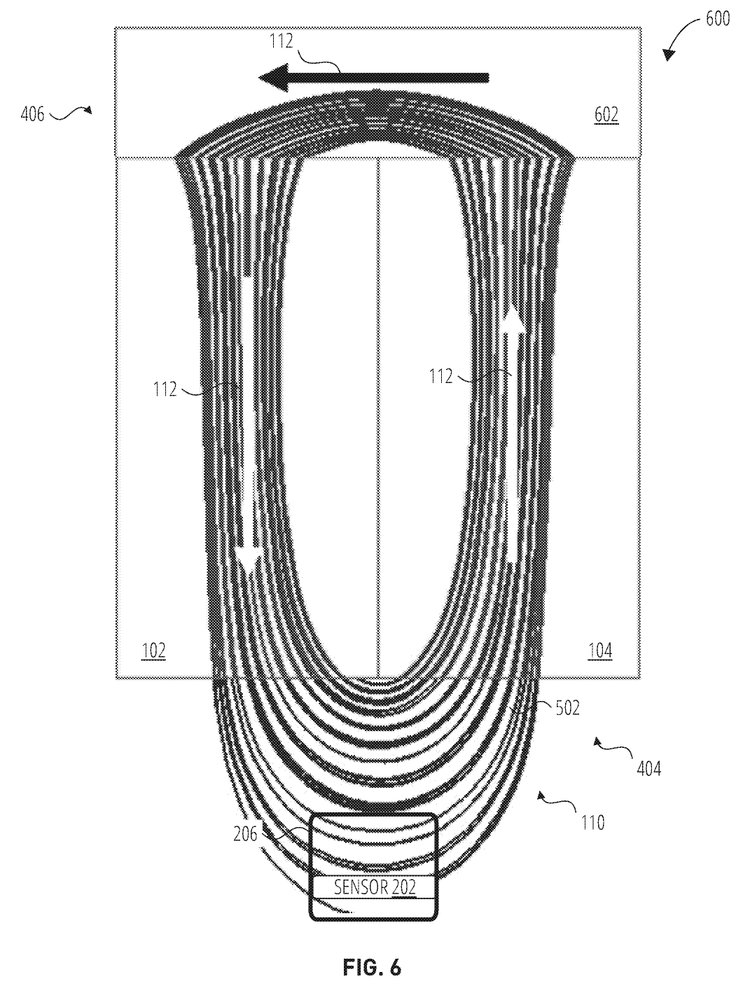

With reference to FIG. 6, an embodiment of a split magnetic assembly 600 is disclosed. The magnetic assembly 600 includes two or more axially magnetized permanent magnets arranged to produce a diametric dipole field at the sensor location. The multi-piece magnetic assembly 600 can have two or more magnetic elements (e.g., a first magnetic element 102 and a second magnetic element 104, similar to those of the magnetic assembly 100 or four magnetic elements with a third magnetic element 302 and 304 similar to the magnetic assembly 300).

An additional magnetic dipole (e.g., an additional magnetic element 602) is placed at an end of the two or more axially magnetized permanent magnets (e.g., the first magnetic element 102, the second magnetic element 104, and if used, the third magnetic element 302 and fourth magnetic element 304) at their non-working end 406. The additional magnetic element 602 is aligned so that it attracts to the field 110 of the non-working end 406 of the magnetic assembly 600. For example, the easy axis 112 of the additional magnetic element 602 may be arranged transverse or normal to the easy axes 112 of the first magnetic element 102, second magnetic element 104, etc. This configuration provides further improved packing density of rotation axes without magnetic field crosstalk.

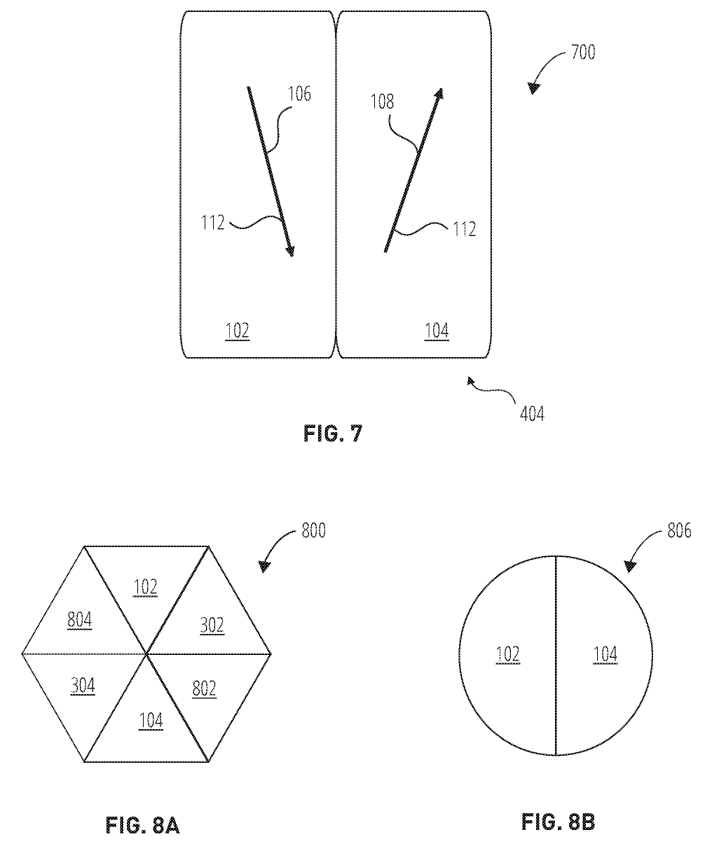

With reference to FIG. 7, an embodiment of a magnetic assembly 700 is disclosed. The magnetic assembly 700 includes two or more axially magnetized permanent magnets arranged to produce a diametric dipole field at the sensor location. The multi-piece magnetic assembly 700 can have two or more magnetic elements (e.g., a first magnetic element 102 and a second magnetic element 104, similar to those of the magnetic assembly 100 or four magnetic elements with a third magnetic element 302 and 304 similar to the magnetic assembly 300).

Additional dipole elements can be added to the magnetic assembly 700 or partially removed from the magnetic assembly 700 so as to tailor the magnetic field 110 for high magnetic uniformity in the working region (e.g., the working end 404) and steeper magnetic field drop outside the working region. Each dipole element in the split magnetic assembly 700 can have the easy axis 112 orientation modified so that it is not orthogonal to the working end 404. Additionally, or alternately, the easy axis 112 of the magnetic elements can be disposed at an angle with respect to one another such that the easy axes 112 are not parallel. The magnetic elements may be oriented with their respective first magnetic moment 106 and second magnetic moment 108 in opposite directions from one another. For example, the easy axes 112 can be tilted in such a manner as to enhance the field 110 or provide a more or less concentrated field at a desired working end 404.

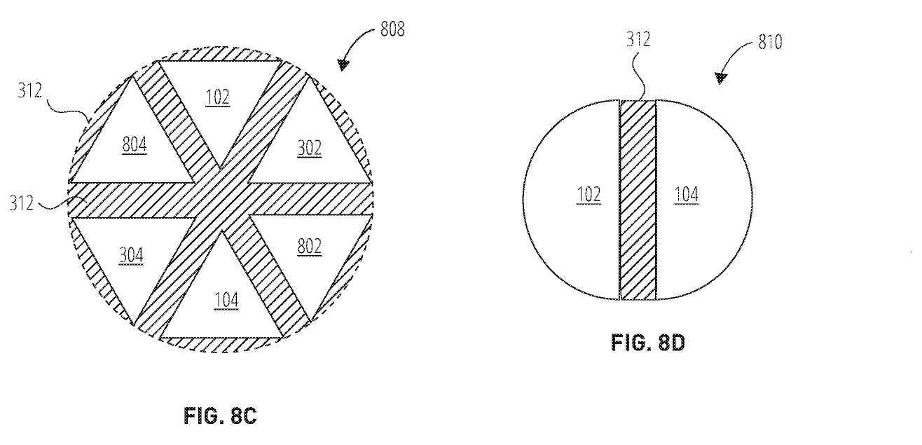

With reference to FIGS. 8A and FIG. 8B, top views of embodiments of a magnetic assembly 800 and magnetic assembly 806 are disclosed. The magnetic assembly 800 and magnetic assembly 806 include two or more axially magnetized permanent magnets arranged to produce a diametric dipole field at the sensor location. The multi-piece magnetic assembly 800 and magnetic assembly 806 can have two or more magnetic elements (e.g., six magnetic elements in the example of the magnetic assembly 800, a first magnetic element 102, second magnetic element 104, third magnetic element 302, fourth magnetic element 304, fifth magnetic element 802, and a sixth magnetic element 804) with axially opposed magnetic moments and/or easy axes 112. The magnetic assembly 800 may include triangle-shaped magnets arranged in a hexagon pattern.

The multi-piece split magnetic assembly 806 can be made with shapes other than rectangular solids such as a triangular or hexagonal prism (e.g., as shown in FIG. 8A) or semi-cylinders (e.g., as shown for example in FIG. 8B). For example, when using triangular magnetic elements, any number of shaped regions can be tessellated by triangular elements, e.g., when viewed in plan view. For example, multiple elements can be used to create magnetic assemblies of the present disclosure having polygonal shapes such as triangular, rhombus, diamond, square, rectangle, trapezoid (e.g., half hexagon), parallelogram, hexagon, pentagon, or higher order polygons, or irregular shapes. Thus, the disclosed magnetic assemblies provide a great deal of design flexibility for encoder applications.

Turning to FIGS. 8C–8D magnetic assemblies 808 and 810 are described. The magnetic assembly 808 is similar to the magnetic assembly 800 in many aspects. The magnetic assembly 810 is similar to the magnetic assembly 806 in many aspects. For example, the magnetic assembly 810 includes a first magnetic element 102, a second magnetic element 104. The magnetic assembly 808 also includes a third magnetic element 302, a fourth magnetic element 304, a fifth magnetic element 802, a sixth magnetic element 804.

Where the magnetic assembly 808 and magnetic assembly 810 differ from the magnetic assembly 800 and magnetic assembly 808 is that an interstitial element 312 is disposed between two or more of the magnetic elements. For example, the interstitial element 312 may be disposed between the first magnetic element 102 and the second magnetic element 104. See, e.g., FIG. 8D. The interstitial element 312 may be disposed between the third magnetic element 302 and the fourth magnetic element 304, the fifth magnetic element 802, and the sixth magnetic element 804. See, e.g., FIG. 8C. The interstitial element 312 may be suitable to shape the field 110 of any of the magnetic assemblies disclosed herein, such as the fields of the magnetic assembly 808 and magnetic assembly 810.

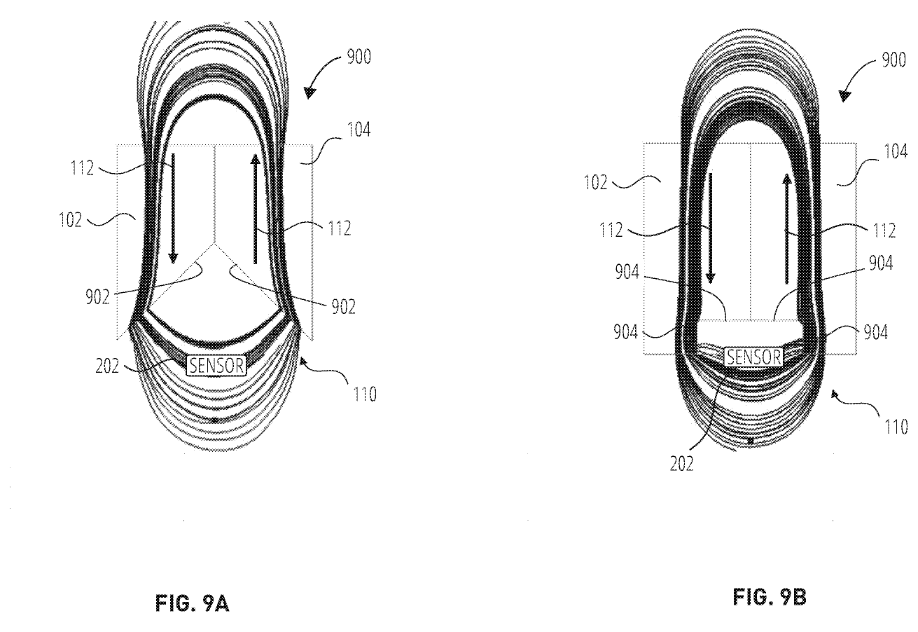

With reference to FIGS. 9A and FIG. 9B, embodiments a magnetic assembly 900 are disclosed. The magnetic assembly 900 includes two or more axially magnetized permanent magnets arranged to produce a diametric dipole field at the sensor location. The multi-piece magnetic assembly 900 can have two or more magnetic elements (e.g., a first magnetic element 102 and a second magnetic element 104, similar to those of the magnetic assembly 100 or four magnetic elements with a third magnetic element 302 and 304 similar to the magnetic assembly 300).

The magnetic field 110 of the magnetic assembly 900 may be modified by physically shaping (e.g., grinding) the magnetic elements. As shown for example in FIG. 9A, the first magnetic element 102 and/or second magnetic element 104 may have facets 902 formed on ends thereof (e.g., the working ends 404). The facets 902 may be disposed at an angle with respect to the easy axis 112 of the respective magnetic element. For example, the facet 902 may form an angle of up to or including any of 10°, 20°, 30°, 45°, 50°, 60°, 70°, 80°, 85°, or any angles therebetween with respect to the easy axis 112 of the magnetic element on which the facet 902 is formed.

Similarly, as shown for example in FIG. 9B, the first magnetic element 102 and/or second magnetic element 104 can have a step or shoulder 904 formed therein (e.g., in a working end 404). The shaping of the magnetic elements in the magnetic assemblies 900 can also reduce the z height requirements, allowing the sensor 202 to be placed in the cavity formed by the facets 902 and/or steps 904.

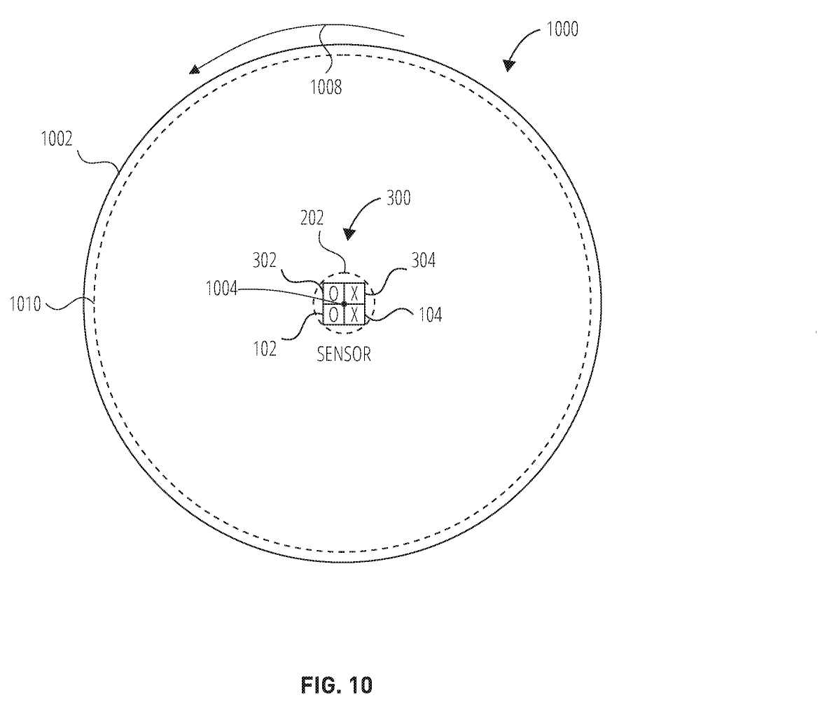

FIG. 10 is a simplified schematic of an example of an encoder 1000 suitable for use with the magnetic assemblies disclosed herein, such as the magnetic assembly 100, the magnetic assembly 300, the magnetic assembly 400, the magnetic assembly 500, the magnetic assembly 600, the magnetic assembly 700, the magnetic assembly 800, the magnetic assembly 900, etc.

The encoder includes a circuit board 1010 housing the sensor 202 and related electronics. The circuit board 1010 is stationary relative to a hub 1002 that rotates about an axis 1004, e.g., in the rotation direction 1008 (although the hub may rotate in an opposite direction to that shown in FIG. 10). A magnetic assembly (e.g., a magnetic assembly 300) is placed at the rotational axis 1004, e.g., may be secured to the rotating hub 1002. The sensor 202 is placed at a stationary location in line with the rotational axis 1004 and in proximity to the magnetic assembly. As the hub 1002 rotates, the sensor 202 detects the field 110 of the magnetic assembly 300 and thus the rotational position of the hub 1002.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader’s understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A magnetic assembly for a rotary encoder, comprising:
at least two axially-magnetized permanent magnets, wherein the magnets are arranged such that their polarities are oriented in opposite directions to produce a concentrated magnetic field.

2. The magnetic assembly of claim 1, wherein the magnetic axes of the at least two permanent magnets are substantially parallel to one another.

3. The magnetic assembly of claim 1, wherein:
the at least two permanent magnets comprise at least four permanent magnets;
at least one of the at least four permanent magnets is arranged adjacent to at least two other of the at least four permanent magnets,
the at least one permanent magnet is oriented with its polarity in a first orientation,
one of the at least two adjacent permanent magnets is oriented with its polarity in the first orientation, and
the other of the at least two adjacent permanent magnets is oriented with its polarity in a second configuration opposite the first configuration.

4. The magnetic assembly of claim 3, wherein the at least four magnets are rectangular and secured in pairs.

5. The magnetic assembly of claim 1, further comprising a ferrous element coupled to a first end of the at least two axially magnetized permanent magnets, wherein a flux conducting element is normal to easy axes of the at least two axially aligned permanent magnets.

6. The magnetic assembly of claim 1, wherein the at least two permanent magnets are arranged to reduce a lateral extension of the magnetic field.

7. The magnetic assembly of claim 1, wherein the at least two permanent magnets are of a same geometric shape or polygonal shape.

8. The magnetic assembly of claim 1, further comprising an additional magnetic dipole disposed at an end of the at least two permanent magnets.

9. The magnetic assembly of claim 1, wherein the at least two permanent magnets includes a facet or a stepped feature disposed at at least one end.

10. The magnetic assembly of claim 1, further comprising an interstitial element disposed between the at least two permanent magnets.

11. The magnetic assembly of claim 10, wherein the at least two permanent magnets are semi cylindrical in shape.

12. The magnetic assembly of claim 10, wherein the interstitial element comprises a magnetically permeable material.

13. The magnetic assembly of claim 10, wherein the interstitial element comprises a magnetically non-permeable material.

14. The magnetic assembly of claim 1, further comprising at least one sensor disposed in the concentrated magnetic field, wherein the at least one sensor is configured to measure a tilt of the magnetic assembly.

15. The magnetic assembly of claim 14, wherein the concentrated magnetic field is disposed on opposite sides of the at least two permanent magnets; and
the at least one sensor comprises:
a first sensor disposed in the concentrated magnetic field on a first side of the opposite sides, and
a second sensor disposed in the concentrated magnetic field on a second of the opposite sides.

16. The magnetic assembly of claim 15, further comprising:
further comprising a ferrous element, wherein:
the at least two permanent magnets comprise at least four permanent magnets;
a first of the at least four permanent magnets is adjacent to a second of the at least four permanent magnets, the first and second permanent magnets forming a first pair of permanent magnets having mutually oppositely-aligned polarities;
a third of the at least four permanent magnets is adjacent to a fourth of the at least four permanent magnets, the third and fourth permanent magnets forming a second pair of permanent magnets having mutually oppositely-aligned polarities;
the ferrous element is disposed between the first pair of permanent magnets and the second pair of permanent magnets;
the first sensor is disposed in the concentrated magnetic field formed by the first pair of permanent magnets; and
the second sensor is disposed in the concentrated magnetic field formed by the second pair of permanent magnets.

17. A rotary encoder comprising:
the magnetic assembly of claim 1; and
a sensor selectively disposed within and configured to detect the concentrated magnetic field.

18. A rotary encoder comprising:
a magnetic assembly comprising:
at least two axially-magnetized permanent magnets, wherein the magnets are arranged such that their magnetic polarities are oriented in opposite directions to produce a concentrated magnetic field; and
at least one sensor selectively disposed within and configured to detect the concentrated magnetic field.

19. The rotary encoder of claim 18, wherein the at least one sensor comprises a magnetoresistance sensor.

20. The rotary encoder of claim 18, wherein preferred magnetic axes of the at least two permanent magnets are substantially parallel to one another.

21. The rotary encoder of claim 18, wherein:
the at least two permanent magnets comprise at least four permanent magnets;
at least one of the at least four permanent magnets is arranged adjacent to at least two other of the at least four permanent magnets,
the at least one permanent magnet is oriented with its magnetic polarity in a first orientation,
one of the at least two adjacent permanent magnets is oriented with its magnetic polarity in the first orientation, and
the other of the at least two adjacent permanent magnets is oriented with its magnetic polarity in a second configuration opposite the first configuration.

22. The rotary encoder of claim 21, wherein the at least four magnets are arranged in a polygonal shape.

23. The rotary encoder of claim 21, wherein the at least four magnets are rectangular and secured in pairs.

24. The rotary encoder of claim 18, further comprising an interstitial element disposed between at least two of the at least two permanent magnets.

25. The rotary encoder of claim 24, wherein the interstitial element comprises a magnetically permeable material.

26. The rotary encoder of claim 24, wherein the interstitial element comprises a magnetically non-permeable material.

27. The rotary encoder of claim 18, wherein the at least one sensor is configured to measure a tilt of the magnetic assembly.

28. The rotary encoder of claim 27, wherein the concentrated magnetic field is disposed on opposite sides of the at least two permanent magnets; and
the at least one sensor comprises:
a first sensor disposed in the concentrated magnetic field on a first side of the opposite sides, and
a second sensor disposed in the concentrated magnetic field on a second of the opposite sides.
